(19) United States
(12) Patent Application Publication
(10) Pub. No.: US 2010/0025559 A1
(43) Pub. Date: Feb. 4, 2010

(54) Universal Antenna Mount

(76) Inventors: Jason Rathbone, Amesbury, MA (US); Frank LaBarba, Newburyport, MA (US)

Correspondence Address: Iandiorio Teska & Coleman, 260 Bear Hill Road, Waltham, MA, 02451, US

(21) Appl. No.: 12/148,905

(22) Filed: Apr. 23, 2008

(51) Int. Cl. H01Q 1/12; F16B 37/00

(52) U.S. Cl. 248/534; 411/383

(57) ABSTRACT

A universal antenna mount featuring a first bracket with a concave face between right and left tangs, a reversible second bracket with a concave face and a generally convex opposite face between right and left tangs, and at least one fastener extending through the right tangs of the first and second brackets and at least one fastener extending through the left tangs of the first and second brackets.

### GOVERNMENT RIGHTS

This invention was made with U.S. Government support under Contract No. W31P4Q-04-C-0020 by the U.S. Army. The Government has certain rights in the subject invention.

### FIELD OF THE INVENTION

This subject invention relates to a more universal system for mounting antennas with different diameter poles to a mast.

### BACKGROUND OF THE INVENTION

Modern mobile battle field electronic enclosures are reconfigurable to support, for example, different missions. Depending on the mission and the configuration of the electronic systems within the enclosure, different antennas may be used. In one example, the enclosure includes several extendable masts for various antennas. The antennas are mounted to a tripod or pole which can range in diameter from 1 to 4 inches.

Conventional U-shape brackets and/or the use of fasteners for securing the antennas to a mast cannot always accommodate the different diameter antenna poles. Also, in the battle field arena, one requirement is that the antennas be easily and quickly mounted to their respective mast and then quickly dismounted. Prior art antenna mounts which require the use of tools are problematic in such a situation.

### SUMMARY OF THE INVENTION

It is therefore an object of this invention to provide a more universal antenna mount.

It is a further object of this invention to provide such an antenna mount which accommodates different diameter antenna poles whether round, square, or of some other shape.

It is a further object of this invention to provide such an antenna mount which is easy to assemble and disassemble.

It is a further object of this invention to provide such an antenna mount which does not require the use of any tools.

It is a further object of this invention to provide an adjustable fastener particularly useful in connection with the universal antenna mount of the subject invention.

The subject invention results from the realization in part that an antenna mount can be made more universal in design if at least one bracket in a pair of brackets is reversible and has one concave face and one generally convex face to accommodate a wide variety of different antenna pole diameters and shapes.

The subject invention, however, in other embodiments, need not achieve all these objectives and the claims hereof should not be limited to structures or methods capable of achieving these objectives.

The subject invention features a universal antenna mount comprising a first bracket with a concave face, a second reversible bracket with a concave face and an opposite generally convex face, and at least one fastener for urging the brackets together to secure a first diameter range of posts between the concave faces of the brackets and a second, smaller diameter range of posts between the concave face of the first bracket and the convex face of the second bracket.

In the preferred embodiment, the convex face of the second bracket includes a recess for gripping a post. Typically, each bracket includes a tang portion. There may be two space fasteners extending through each tang portion. One preferred fastener includes an adjustable length shank with at least two slots. Then, one said bracket includes a pin receivable in the slots.

One universal antenna mount in accordance with the subject invention includes a first bracket with a concave face between right and left tangs and a reversible second bracket with a concave face and a generally convex opposite face between right and left tangs. At least one fastener extends through the right tangs of the first and second brackets and at least one fastener extends through the left tangs of the first and second brackets. The preferred fastener includes an adjustable length shank with at least two spaced slots. Then, one of the tangs includes an orifice for the adjustable length shank and a pin traversing the orifice.

Further included are brackets for securing one said tang to a mast. One bracket is a straight plate; another bracket is an angled plate.

The subject invention also features an adjustable length fastener system comprising a shaft including at least two spaced slots and a threaded portion. A nut is threadable on the threaded portion. The shaft is received through an orifice with a pin traversing the orifice receivable in one slot in the shaft.

One antenna mounting system in accordance with this invention includes a mast with one or more universal antenna mounts thereon. Each antenna mount includes a first bracket with a concave face, a second reversible bracket with a concave face and an opposite generally convex face, and at least one fastener for urging the brackets together to secure a first diameter range of posts between the concave faces of the brackets and a second, smaller diameter range of posts between the concave face of the first bracket and the convex face of the second bracket.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional front view of an example of a universal antenna mount in accordance with the subject invention;

FIG. 2 is another schematic three-dimensional view of the antenna mount of FIG. 1;

FIG. 3 is a schematic three-dimensional exploded view showing the primary components associated with one bracket of the antenna mount shown in FIGS. 1 and 2;

FIG. 4 is a highly schematic three-dimensional view showing two antenna mounts in accordance with the subject invention mounted to an extendable mast;

FIG. 5 is a highly schematic three-dimensional view showing two antenna mounts in accordance with the subject invention mounted to an extendable mast and also showing an interface on the mast for another type of antenna;

FIGS. 6A-6G are schematic top views showing how the universal antenna mount of the subject invention accommodates different diameter antenna poles;

FIG. 7 is a schematic three-dimensional view showing one type of antenna mounted to a universal antenna mount in accordance with the subject invention;

FIG. 8 is a highly schematic three-dimensional view showing another type of antenna mounted to the same universal antenna mount; and

FIG. 9 is a schematic three-dimensional view showing how the universal antenna mount of the subject invention can accommodate an adaptor useful for mounting different types of antennas.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

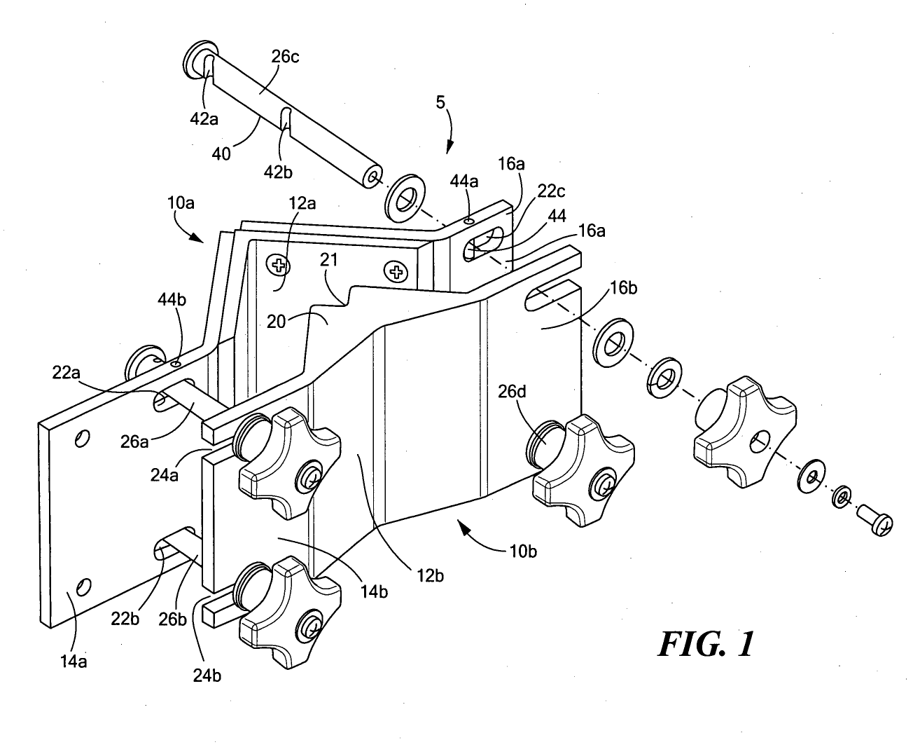

FIG. 1 depicts an example of a universal antenna mount in accordance with the subject invention. Bracket 10a includes concave face 12a between left tang 14a and right tang 16a. Reversible bracket 10a includes concave face 12b between left tang 14b and right tang 16b and opposite generally convex face 20 with recess 21. To urge the two brackets together, left tang 14a of bracket 10a includes orifices 22a and 22b and left tang 14b of bracket 10b includes recesses 24a and 24b. Fasteners 26a and 26b extend, respectively, through orifice 22a and recess 24a and through orifice 22b and recess 24b. Right tangs 16a and 16b include a similar construction to accept fasteners 26c and 26d as shown.

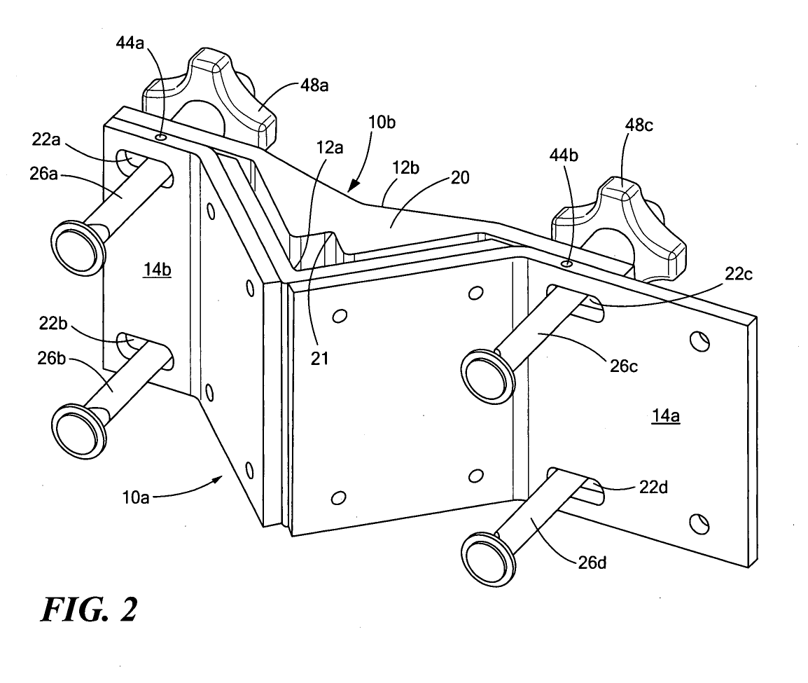

In one preferred embodiment, each fastener, as shown for fastener 26c, includes adjustable length shaft 40 with spaced slots 42a and 42b. Pin 44 traverses orifice 22c and thus locks slot 44a or 42b in place with respect to tang 16a. FIG. 2 shows all the fasteners 26a-26d adjusted so their respective nuts 48a-48d do not need to be threaded along the vast majority of the shank of each fastener in order to urge bracket 10a in proximity to bracket 10b around an antenna pole. This feature allows quick coupling of a small diameter antenna pole between brackets 10a and 10b.

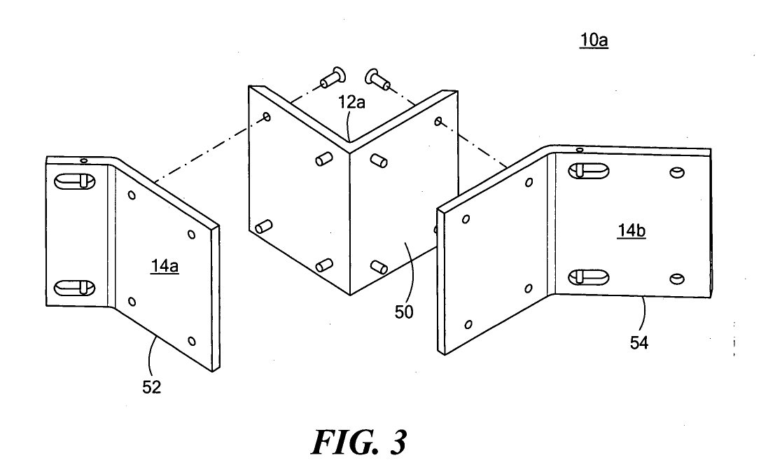

FIG. 3 shows one construction of bracket 10a wherein convex face 12a is formed via right angle bracket 50 and tangs 14a and 14b are formed by angled brackets 52 and 54, respectively.

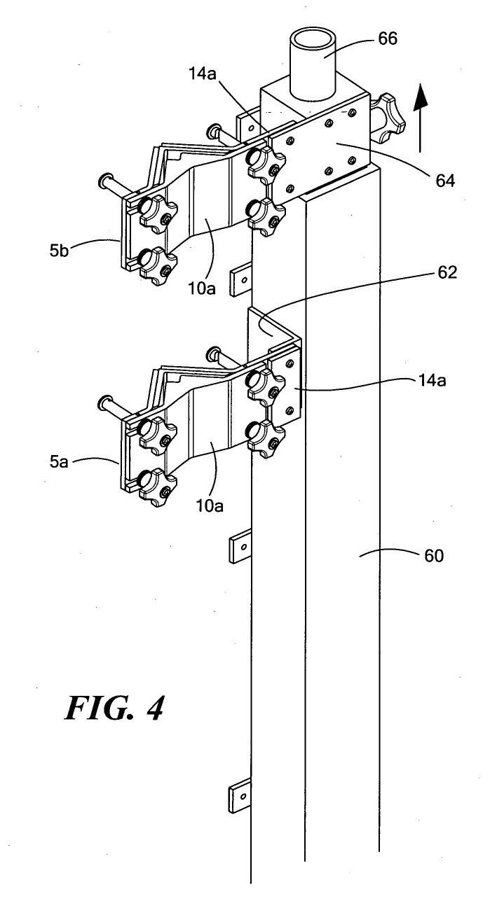

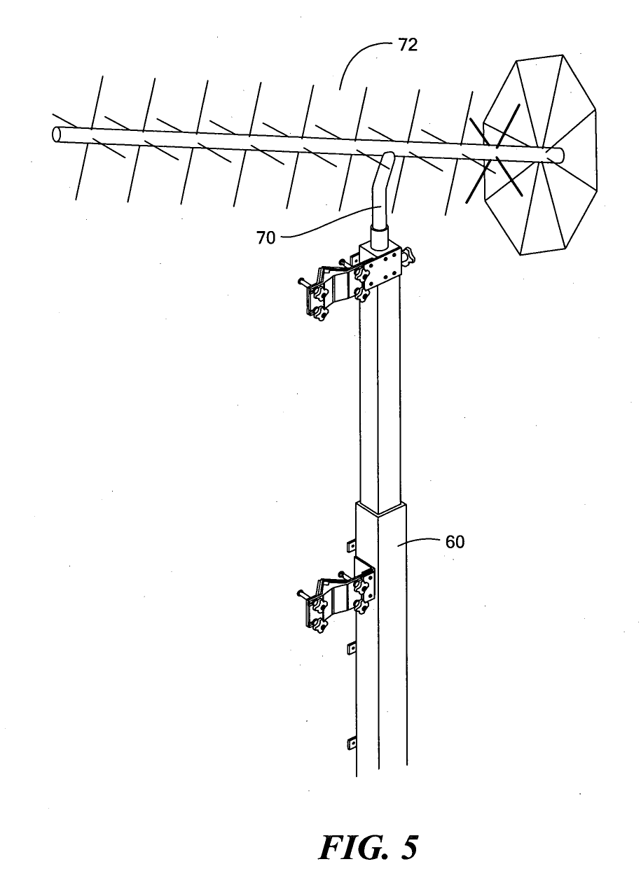

FIG. 4 shows two universal antenna mounts 5a and 5b on mast 60. Right angle bracket 62 attaches to mast 60 and tang 14a of bracket 10a to secure antenna mount 5a to mast 60 and straight bracket 64 attaches to mast 60 and tang 14a of bracket 10a to secure antenna mount 5b to mast 60. Mast 60 also includes interface 66 adapted to receive, in this example, the post 70 of SATCOM antenna 72, FIG. 5 once it is removed from its tripod. FIG. 5 also shows mast 60 in its extended position.

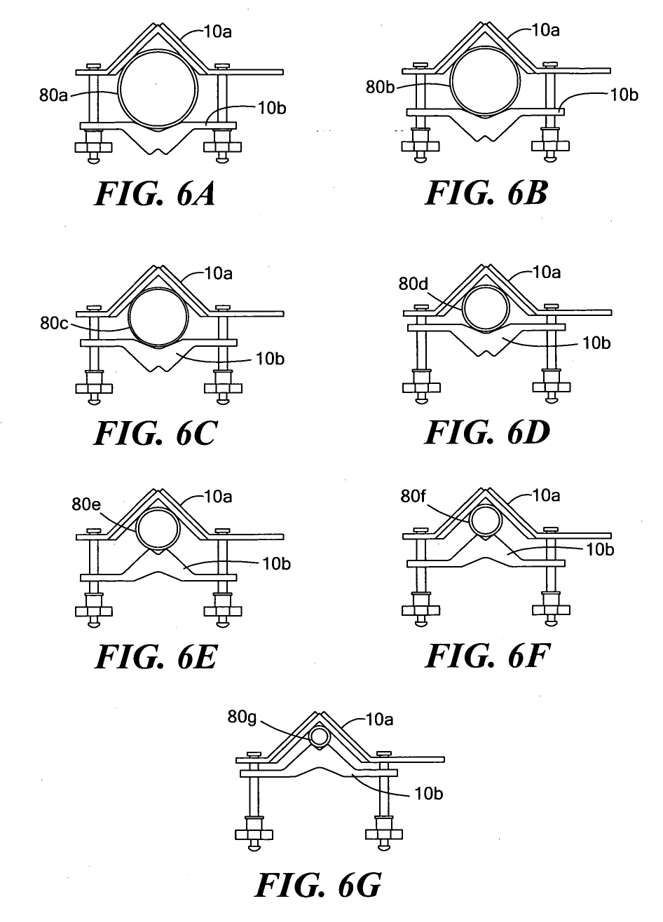

FIGS. 6A-6G show how universal antenna mount 5 can accommodate a wide variety of antenna pole diameters. In FIGS. 6A-6D, bracket 10b is oriented so its concave face side clamps, with the concave face of bracket 10a, antenna poles 80a-80d ranging in diameter from 4 to 2.5 inches. Then, by reversing bracket 10b, as shown in FIGS. 6E-6G, the convex face thereof can be used to secure, with bracket 10a, antenna poles 80e-80g ranging in diameter from 2 inches to 1 inch. Antenna poles of different shapes can similarly be accommodated by the mount of the subject invention.

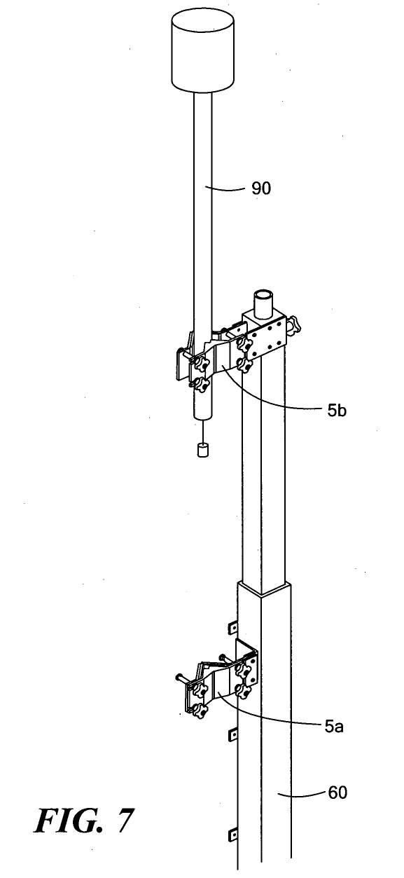

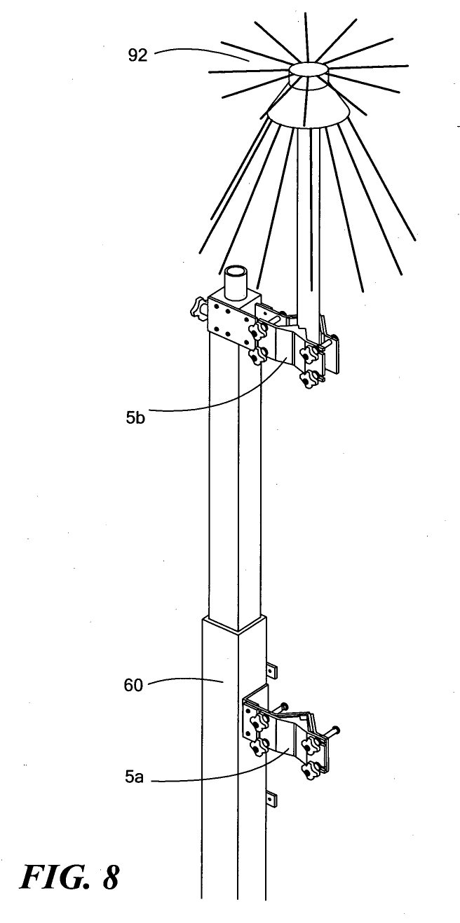

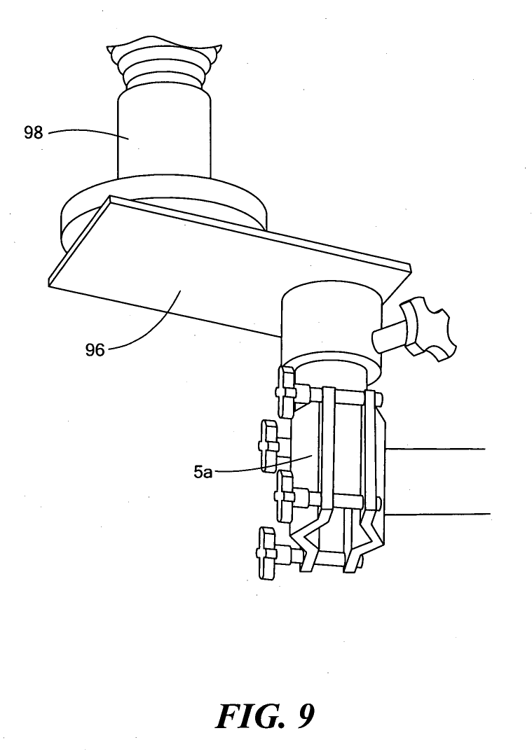

FIG. 7 shows mount 5b with ANT400K antenna 90 and FIG. 8 shows mount 5b with AT-197 antenna 92. FIG. 9 shows mount 5a with adaptor 96 clamped therein for SINCGARS (or EPLRS) antenna 98.

The result, in any embodiment is a more universal antenna mount which accommodates different diameter and shape antenna poles. The antenna mount is easy to assemble and disassemble and in the preferred embodiment does not require to use of any tools.

The subject invention also features an adjustable fastener as disclosed herein which is particularly useful in connection with the universal antenna mount of the subject invention but may have uses apart from the universal antenna mount.

The preferred universal antenna mount of the subject invention is particularly well suited for use with height reducible electronics enclosures. The invention could be implemented, however, on any tactical electronics enclosure where antennas are used and also has a broad commercial application where mounting a broad range of different diameter or shapes of antenna pole are required. But, subject mount is not limited to antennas and has applicability to secure tubes or masts or the like of varying sizes and shapes whether circular, square, or some other shape. The broad diameter range (in the example disclosed herein, 1 inch to 4 inches) allows the mount to accept multiple antenna types including, but not limited to, ACUS dish, ANT400K, AV2011, DM-SE109, MIDS, and JTIDS antennas. The mount also provides an option for personnel to place what are typically ground-mount tripods on the roof of shelters which minimizes trip hazards. Conveniently, no tools are required to emplace or swap antenna types.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A universal antenna mount comprising:
a first bracket with a concave face;
a second reversible bracket with a concave face and an opposite generally convex face; and
at least one fastener for urging the brackets together to secure a first diameter range of posts between the concave faces of the brackets and a second, smaller diameter range of posts between the concave face of the first bracket and the convex face of the second bracket.

2. The universal antenna mount of claim 1 in which the convex face of the second bracket includes a recess for gripping a post.

3. The universal antenna mount of claim 1 in which each bracket includes a tang portion.

4. The universal antenna mount of claim 3 in which there are two space fasteners extending through each tang portion.

5. The universal antenna mount of claim 1 in which the fastener includes an adjustable length shank.

6. The universal antenna mount of claim 5 in which the adjustable length shank includes at least two slots.

7. The universal antenna mount of claim 6 in which one said bracket includes a pin receivable in the slots.

8. A universal antenna mount comprising:
a first bracket with a concave face between right and left tangs;
a reversible second bracket with a concave face and a generally convex opposite face between right and left tangs; and
at least one fastener extending through the right tangs of the first and second brackets and at least one fastener extending through the left tangs of the first and second brackets.

9. The antenna mount of claim 8 in which the fastener includes an adjustable length shank.

10. The antenna mount of claim 9 in which the adjustable length shank includes at least two spaced slots.

11. The antenna mount of claim 10 in which at least one of said tangs includes an orifice for the adjustable length shank and a pin traversing the orifice receivable in a slot in the shank.

12. The antenna mount of claim 8 further including a bracket for securing one said tang to a mast.

13. The antenna mount of claim 12 in which said bracket is a straight plate.

14. The antenna mount of claim 12 in which said bracket is an angled plate.

15. An adjustable length fastener system comprising:
a shaft including at least two spaced slots and a threaded portion;
a nut threadable on the threaded portion;
a member including an orifice therethrough for receiving the shaft; and
a pin traversing the orifice and receivable in a slot in the shaft.

16. An antenna mounting system comprising:
a mast including one or more universal antenna mounts thereon, each antenna mount comprising:
a first bracket with a concave face,
a second reversible bracket with a concave face and an opposite generally convex face, and
at least one fastener for urging the brackets together to secure a first diameter range of posts between the concave faces of the brackets and a second, smaller diameter range of posts between the concave face of the first bracket and the convex face of the second bracket.

17. The system of claim 16 in which the convex face of the second bracket includes a recess for gripping a post.

18. The system of claim 16 in which each bracket includes a tang portion.

19. The system of claim 18 in which there are two spaced fasteners extending through each tang portion.

20. The system of claim 19 in which a fastener includes an adjustable length shank.

21. The system of claim 20 in which the adjustable length shank includes at least two slots.

22. The system of claim 21 in which one said bracket includes a pin receivable in a slot.
